(19) United States
(12) Patent Application Publication
(10) Pub. No.: US 2014/0042227 A1
(43) Pub. Date: Feb. 13, 2014

(54) PAPER MEDIUM AND READING DEVICE

(71) Applicant: Brother Kogyo Kabushikia Kaisha, Nagoya-shi (JP)

(72) Inventor: Takehiko INABA, Aichi-ken (JP)

(73) Assignee: BROTHER KOGYO KABUSHIKIA KAISHA, Nagoya-shi (JP)

(21) Appl. No.: 13/958,722

(22) Filed: Aug. 5, 2013

(30) Foreign Application Priority Data
Aug. 7, 2012 (JP) 2012-174823

(51) Int. Cl. G06K 7/14; G06K 19/06

(52) U.S. Cl. CPC G06K 7/1443; G06K 19/06046
USPC 235/454; 235/494

(57) ABSTRACT

A paper medium has a mark provided at each of predetermined positions corresponding to paper medium information that is predetermined information relating to the paper medium. A reading device has a placement, device, a specification device, a detection device, a storage device, and an identification device. The specification device specifies a position on the paper medium placed on the placement device. The detection device detects the position specified on the placement device by the specification device. The storage device stores associated information that is information in which a mark corresponding position corresponding to a predetermined position in which a mark is arranged is associated with paper medium information. The identification device refers to the associated information, and identifies the paper medium information when the position on the placement device detected by the detection device is the mark corresponding position.

### CROSS-REFERENCE TO RELATED APPLICATION

This Application claims priority to Japanese Patent Application No. 2012-174823, filed on Aug. 7, 2012, the content of which is hereby incorporated by reference.

### BACKGROUND

The present disclosure relates to a paper medium and a reading device that reads content written on the paper medium.

A device is known that reads and stores a position on a sheet of paper on which a user performs writing, and thereby stores content written on the sheet of paper by the user. For example, a handwriting input device is known that includes a handwriting input portion and a code reader. A user of the handwriting input device places a paper medium, on which a barcode is written, on a platform of the handwriting input portion. The barcode indicates information relating to the paper medium, such as, for example, a document name, a page number, a personal computer name or a personal computer IP address. The code reader reads the barcode of the paper medium placed on the platform. When the user performs writing on the paper medium using an electromagnetic pen, the handwriting input portion detects coordinates of a writing position on the paper medium. Written data indicated by the detected writing position is stored in document data of the page number indicated by the barcode. Note that a two-dimensional code can be used instead of the barcode. The barcode and the two-dimensional code represent information based on a difference in a pattern. Specifically, the barcode represents information based on a slight difference in the thickness of striped lines, and the two-dimensional code represents information by arranging small dots in a matrix.

### SUMMARY

However, the barcode and the two-dimensional code are used by devices to detect information, and it is therefore difficult for a person to distinguish the difference in the pattern (the line thickness difference or the dot position difference). Accordingly, it is difficult to recognize the information relating to the paper medium even if the person performs a visual check.

The present disclosure provides a paper medium and a reading device that make it possible to recognize information relating to the paper medium by visually checking the paper medium.

Exemplary embodiments provide a paper medium that includes a mark that is provided at each of predetermined positions corresponding to paper medium information that is predetermined information relating to the paper medium.

Exemplary embodiments also provide a reading device that includes a processor, and a memory configured to store associated information that is information in which a mark corresponding position is associated with paper medium information on a placement device that is configured to which the paper medium according to any one of claims 1 to 12 is placed on, the mark corresponding position being a position corresponding to a predetermined position in which a mark is arranged, and to store computer-readable instructions therein. The computer-readable instructions instruct the processor to perform processes includes detecting a position specified on the placement device, determining whether the position detected on the placement device is the mark corresponding position, referring to the associated information, and identifying the paper medium information associated with the mark corresponding position when the detected position is the mark corresponding position.

Exemplary embodiments further provides a reading device that includes a placement device that is configured to which the paper medium according to any one of claims 1 to 12 is placed on, a specification device that specifies a position on the paper medium placed on the placement device, a detection device that is provided on the placement device and that detects the position specified on the placement device by the specification device, a storage device that stores associated information that is information in which a mark corresponding position is associated with paper medium information, the mark corresponding position being a position on the placement device that corresponds to a predetermined position in which a mark is arranged, and an identification device that refers to the associated information stored in the storage device, and identifies the paper medium information associated with the mark corresponding position when the position on the placement device detected by the detection device is the mark corresponding position.

### BRIEF DESCRIPTION OF THE DRAWINGS

Embodiments will be described below in detail with reference to the accompanying drawings in which:

FIG. 1 is a diagram showing a configuration of a handwriting input system;

FIG. 2 is a block diagram showing an electrical configuration of a reading device;

FIG. 3 is a plan view of a paper medium;

FIG. 4 is a data configuration diagram of an associated information data table;

FIG. 5 is a flowchart of main processing;

FIG. 6 is a plan view of the paper medium on which check marks etc. are written;

FIG. 7 is a diagram showing the paper medium displayed on a display;

FIG. 8 is a data configuration diagram of a coordinate data table;

FIG. 9 is a diagram showing the paper medium displayed on the display in a state in which the characters “ABC” are written;

FIG. 10 is a plan view of a paper medium according to a modified example of the paper medium;

FIG. 11 is a plan view of a paper medium according to another modified example of the paper medium; and

FIG. 12 is a plan view of a paper medium according to yet another modified example of the paper medium.

### DETAILED DESCRIPTION

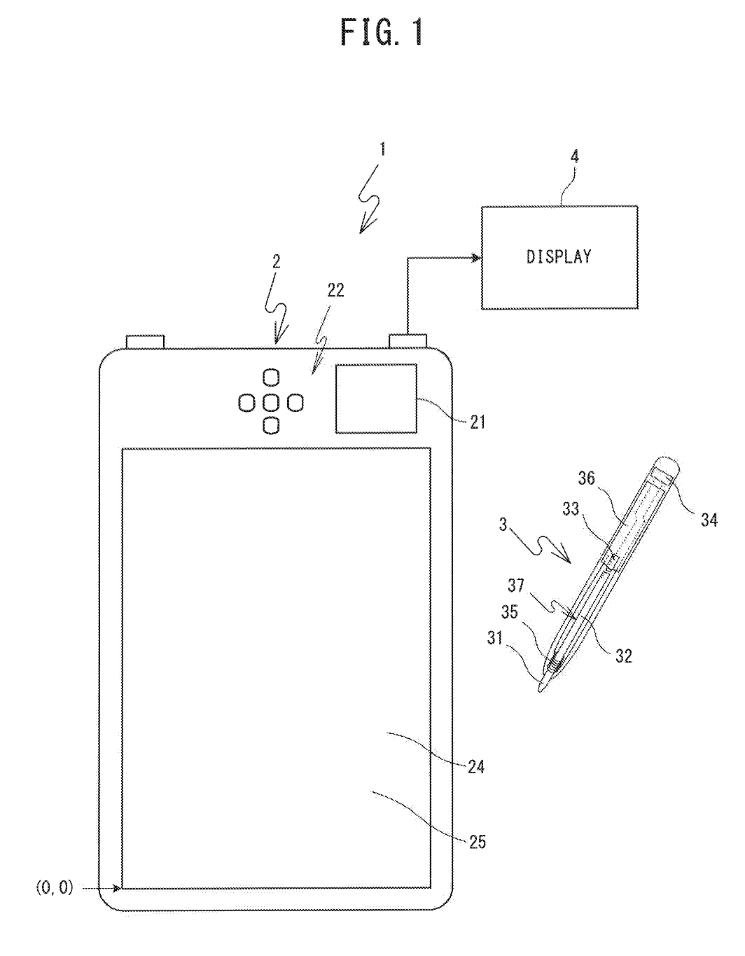

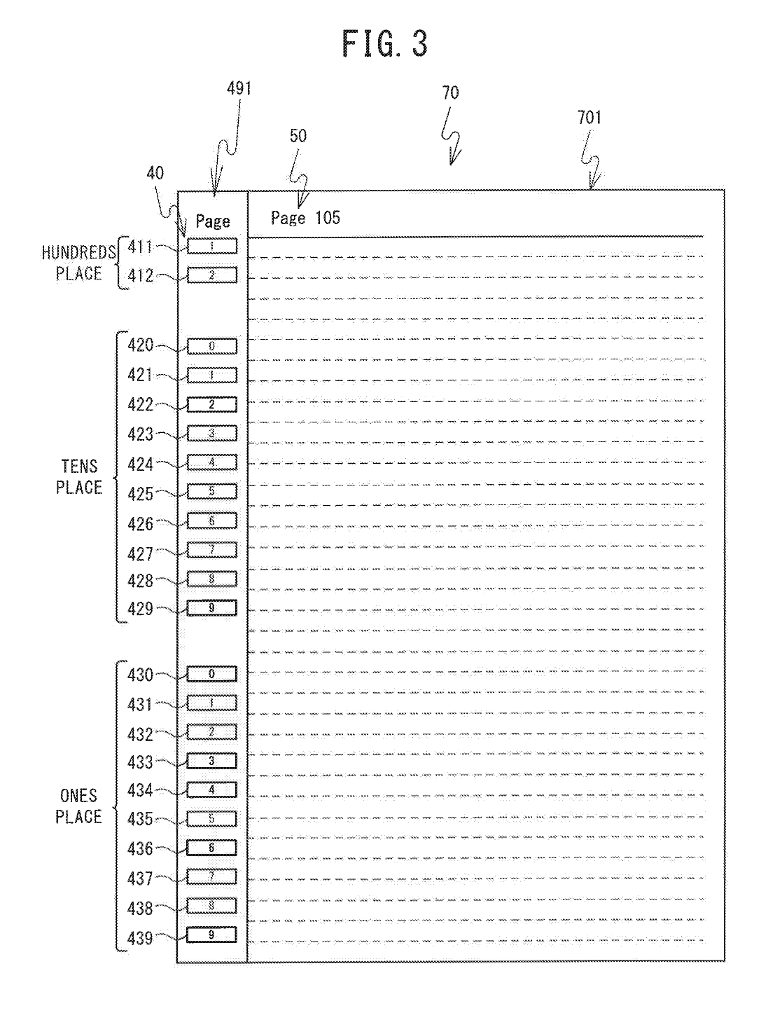

Hereinafter, embodiments of the present disclosure will be explained with reference to the drawings. Note that the drawings are used to explain technological features that the present disclosure can adopt, and the drawings are not intended to limit content. An outline of a handwriting input system 1 according to an embodiment will be explained with reference to FIG. 1. In the explanation below, the left side, the right side, the lower side, the upper side, the front side and the back side of FIG. 1 are respectively defined as the left side, the right side, the front side, the rear side, the upper side and the lower side of a reading device 2. In the explanation below, various types of paper media including a paper medium 701 (refer to FIG. 3) are described. When the paper media are collectively referred to or when they are not particularly distinguished, they are referred to as a paper medium 70. Further, when check boxes on the paper medium 70 are collectively referred to or when they are not particularly distinguished, they are referred to as check boxes 40.

As shown in FIG. 1, the handwriting input system 1 includes the reading device 2, an electronic pen 3 and a display 4. The handwriting input system 1 is a system that stores and displays content (hereinafter referred to as written content) that is written on the paper medium 70 (refer to FIG. 3) by a user using the electronic pen 3 of an electromagnetic induction type and the reading device 2. Note that, for explanatory purposes, FIG. 1 schematically shows an internal structure of the electronic pen 3.

The reading device 2 has a rectangular parallelepiped shape that is long in the front-rear direction in a plan view and thin in the up-down direction. The display 4 having a compact size is provided on a rear right portion (the upper right of FIG. 1) of the reading device 2. Various types of information may be displayed on the display 4. An input portion 22 is provided on the left side of the display 4. The user can input various commands to the reading device 2 using the input portion 22. On the front side of the display 4 and the input portion 22, a placement portion 24 is provided over a front end portion of the reading device 2. The paper medium 70 may be placed on the placement portion 24. Provided on the placement portion 24 is a coordinate detection portion 25 that detects a position on the placement portion 24 specified by the electronic pen 3. The placement portion 24 and the coordinate detection portion 25 are provided in the same region on the top surface of the reading device 2. Further, the placement portion 24 and the coordinate detection portion 25 have substantially the same shape as that of the paper medium 70 (refer to FIG. 3) in a plan view.

The electronic pen 3 will be explained. The direction in which a pen tip 31 of the electronic pen 3 is provided is referred to as a leading end direction. Further, the direction that is opposite to the leading end direction is referred to as a rear end direction. The electronic pen 3 includes a core 37, a detection switch 33, a button-shaped battery 34, a coil 35 and a board 36. The core 37 is made of metal. The core 37 is formed by the pen tip 31 and an ink storage portion 32. The core 37 is provided inside a leading end portion of the electronic pen 3, and is constantly urged in the leading end direction by an elastic member (not shown in the drawings). Therefore, the pen tip 31 protrudes to the outside of the electronic pen 3. The ink storage portion 32 stores ink. The ink stored in the ink storage portion 32 is supplied to the pen tip 31. Thus, the user can write various types of characters (such as letters, numerals, graphics and the like) on the paper medium 70 using the electronic pen 3.

The board 36 is provided on the rear end direction side of the core 37. The detection switch 33 is mounted on a leading end portion of the board 36. The battery 34 is provided in the rear end direction of the board 36. The battery 34 is connected to the board 36. A minus-side electrode of the battery 34 is electrically connected to the coil 35 via wiring on the board 36. A plus-side electrode of the battery 34 is electrically connected to the detection switch 33 via the wiring on the board 36. The detection switch 33 is electrically connected to the coil 35 via the wiring on the board 36.

The coil 35 is wound around the core 37 in the leading end portion of the inside of the electronic pen 3. When the user writes characters etc. on the paper medium 70 using the electronic pen 3, the core 37 is retracted a little toward the inside of the electronic pen 3 against an urging force of the elastic member, due to a pressing force generated when the electronic pen 3 is pressed against the paper medium 70. Due to the retraction of the core 37, a rear end portion of the core 37 depresses the detection switch 33 and the detection switch 33 is turned on. As a result of the above-described movement, the battery 34 and the coil 35 are electrically connected, and a current flows from the battery 34 toward the coil 35. When the current flows through the coil 35, a magnetic field is generated. The coordinate detection portion 25 of the reading device 2 detects the generated magnetic field and thereby detects a position (coordinates) at which writing is performed by the user. Note that, in the present embodiment, coordinates (X, Y) of the front left (the lower left of FIG. 1) of the coordinate detection portion 25 are defined as (0, 0). Note that it is defined that the coordinate “X” represents a position, in the left-right direction, in the coordinate detection portion 25 (the placement portion 24) and the right direction is a plus direction. It is defined that the coordinate “Y” represents a position in the front-rear direction and the rear direction is a plus direction.

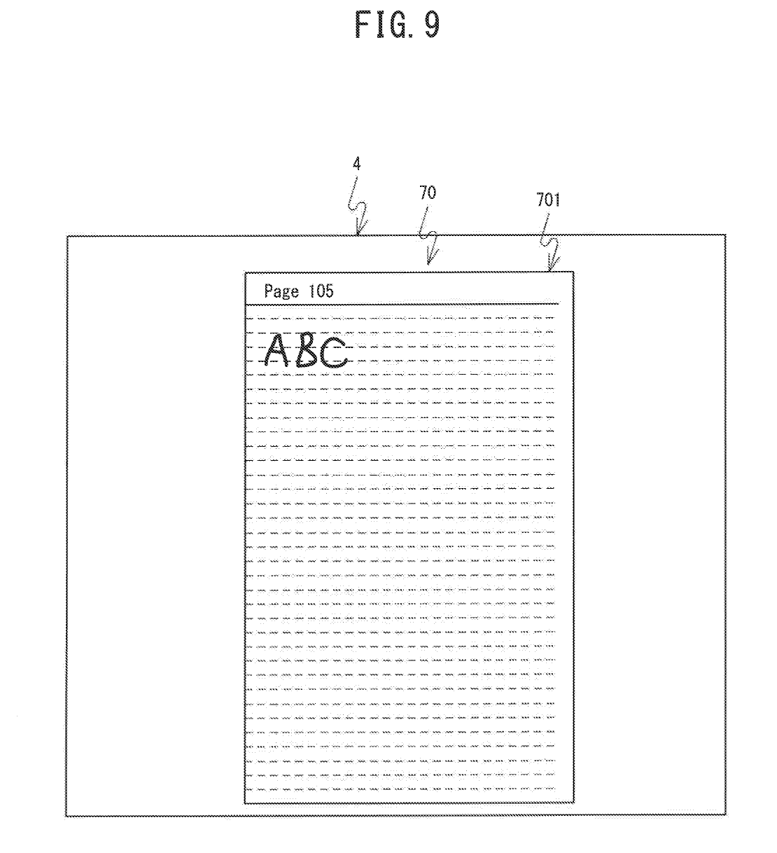

The reading device 2 is connected to the display 4. The display 4 may display an image that corresponds to the paper medium 70 placed on the placement portion 24 of the reading device 2 by the user, and the written content (refer to FIG. 9).

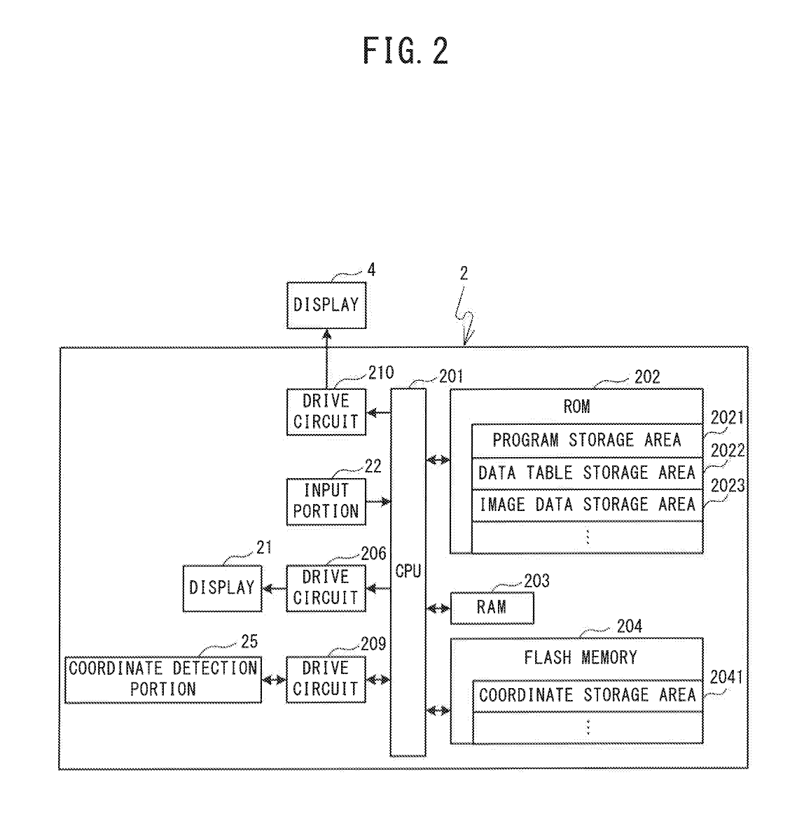

An electrical configuration of the reading device 2 will be explained with reference to FIG. 2. As shown in FIG. 2, the reading device 2 includes a CPU 201, a ROM 202, a RAM 203 and a flash memory 204. The ROM 202, the RAM 203 and the flash memory 204 are electrically connected to the CPU 201.

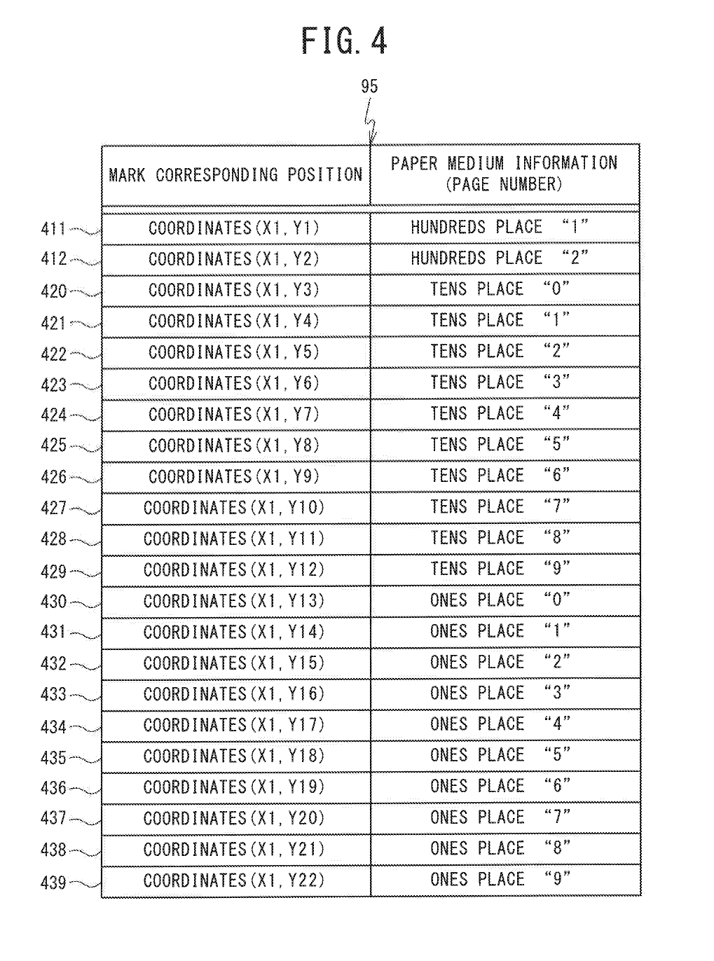

The CPU 201 performs control of the reading device 2. The ROM 202 includes at least a program storage area 2021, a data table storage area 2022 and an image data storage area 2023. The program storage area 2021 stores various types of programs performed by the CPU 201 to control the reading device 2. The data table storage area 2022 stores an associated information data table 95 (refer to FIG. 4) that will be described later. The image data storage area 2023 stores data of an image corresponding to paper medium information that will be described later.

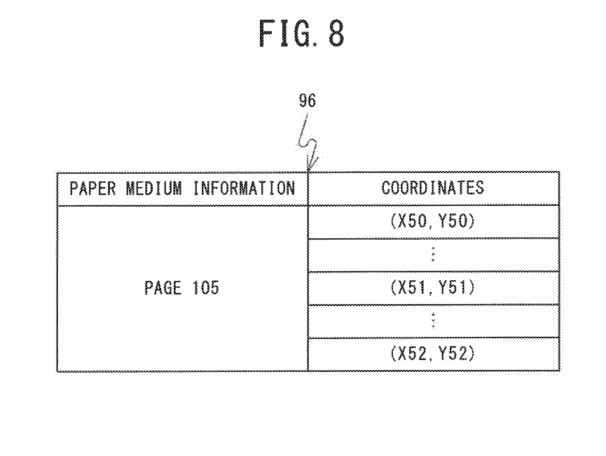

The flash memory 204 includes at least a coordinate storage area 2041. The coordinate storage area 2041 stores a coordinate data table 96 (refer to FIG. 8) that will be described later. The RAM 203 temporarily stores various types of data.

The reading device 2 includes the input portion 22 and drive circuits 206, 209 and 210. The input portion 22 and the drive circuits 206, 209 and 210 are electrically connected to the CPU 201. The drive circuit 206 may drive a display 21. The drive circuit 209 may drive the coordinate detection portion 25. The drive circuit 210 may cause the display 4 to display an image.

A paper medium 701, which is an example of the paper medium 70, will be explained with reference to FIG. 3. In the explanation below, the lower side, the upper side, the left side and the right side of FIG. 3 are respectively defined as the front side, the rear side, the left side and the right side of the paper medium 70. The paper medium 701 is a paper medium of the page number “Page 105” among a plurality of sheets of the paper medium 70. An illustration of pages except the page 105 is omitted in FIG. 3.

The paper medium 701 has a rectangular shape that is long in the front-rear direction in a plan view. A mark arrangement section 491 is provided in a left end portion of the paper medium 701 such that the mark arrangement section 491 extends in the front-rear direction. The mark arrangement section 491 is a section in which the check boxes 40 (more specifically, check boxes 411, 412 and 420 to 439) are provided. The mark arrangement section 491 is colored in gray. In other words, the mark arrangement section 491 is subjected to processing (processing to perform gray coloring) different from that of white other sections (sections to the right of the mark arrangement section 491).

The check boxes 411, 412 and 420 to 439 are provided in predetermined positions corresponding to the paper medium information. The paper medium information is predetermined information relating to the paper medium 70. The paper medium information indicated by the check boxes 411, 412 and 420 to 439 is the page number.

The check boxes 411, 412 and 420 to 439 will be explained in more detail. In a left portion of the paper medium 701, the two check boxes 411 and 412, the ten check boxes 420 to 429 and the ten check boxes 430 to 439 are provided in a row in the front-rear direction. The positions of the check boxes 411 and 412 correspond to the hundreds place of the page number. The position of the check box 411 represents “1” in the hundreds place, and the position of the check box 412 represents “2” in the hundreds place.

The positions of the check boxes 420 to 429 correspond to the tens place of the page number, and respectively represent “0” to “9” in the tens place. The positions of the check boxes 430 to 439 correspond to the ones place of the page number, and respectively represent “0” to “9” in the ones place.

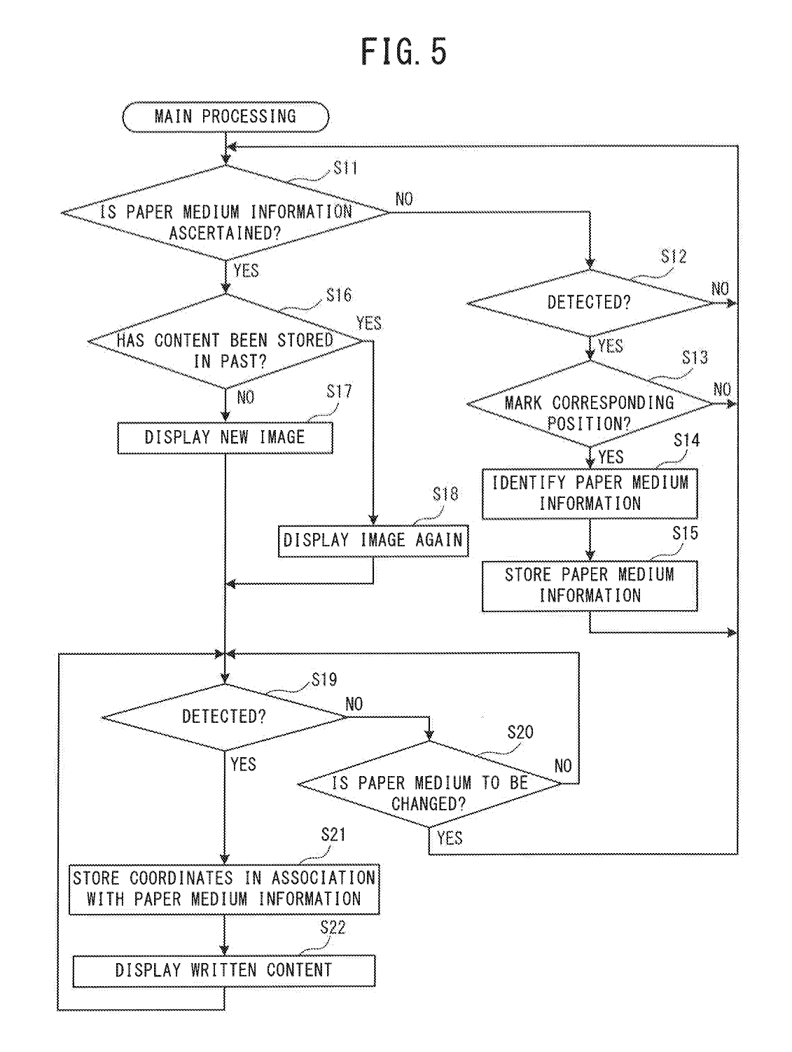

Among the check boxes 411, 412 and 420 to 439, the check boxes 411, 420 and 435 are white on the colored background. The other check boxes 412, 421 to 434 and 436 to 439 are all painted in gray. It is indicated by the white check boxes 411, 420 and 435 that the hundreds place of the page number is “1”, the tens place is “0”, and the ones place is “5”. That is, the paper medium information “Page 105” of the paper medium 701 is represented by the positions of the white check boxes 411, 420 and 435. The user memorizes in advance a relationship between the positions of the check boxes 411, 412, 420 to 439 and the page number (the paper medium information) represented by each of the positions. The user can recognize that the page number of the paper medium 701 is “Page 105”, by confirming the positions of the white check boxes 411, 420 and 435. Although details will be described later, if the user checks the check boxes 411, 420 and 435 using the electronic pen 3 in a state in which the paper medium 701 is placed on the placement portion 24 of the reading device 2, it is identified by the reading device 2 that the page number of the placed paper medium 701 is “Page 105” (refer to step S14 of FIG. 5).

A character description portion 50 is provided to the right of the mark arrangement section 491 in a rear left portion of the paper medium 701. Since the page number of the paper medium 701 is “Page 105”, the characters “Page 105” are written in the character description portion 50. In other words, the characters that indicate the content of the paper medium information of the paper medium 701 are written in the character description portion 50.

The associated information data table 95 will be explained with reference to FIG. 4. The associated information data table 95 is stored in the data table storage area 2022 (refer to FIG. 2). As shown in FIG. 4, in the associated information data table 95, mark corresponding positions are associated with the paper medium information (the page number). The mark corresponding positions are set to positions (coordinates) on the placement portion 24 that correspond to positions on the paper medium 70 in which the check boxes 411, 412 and 420 to 439 are arranged. For example, coordinates (X1, Y1) on the placement portion 24 are associated with the hundreds place “1”. Note that, for explanatory purposes, FIG. 4 shows the reference numerals 411, 412, 420 to 439 of the check boxes that correspond to respective sets of coordinates indicated by the mark corresponding positions. In each of the mark corresponding positions shown in FIG. 4, one set of coordinates (for example, the coordinates (X1, Y1)) only are described. However, actually, coordinates corresponding to a rectangular range of each of the check boxes 411, 412 and 420 to 439 are stored.

Main processing will be explained with reference to FIG. 5. When a power source of the reading device 2 is turned on, the CPU 201 reads out a program for the main processing from the program storage area 2021 of the ROM 202. The CPU 201 performs the main processing in accordance with instructions of the read-out program. In the explanation below, a step of a flowchart is simply referred to as “S”.

Before or after performing an operation to turn on the power source of the reading device 2, the user prepares the paper medium 70 to be placed on the placement portion 24. For example, the user places a plurality of sheets of the paper medium 70 on the placement portion 24. Then, the user opens the page number “Page 105” of the paper medium 70, namely, the paper medium 701 (refer to FIG. 3). At this time, the user visually checks the positions of the white check boxes 411, 420 and 435. The check boxes 411, 420 and 435 are provided corresponding to the paper medium information “Page 105” of the paper medium 701. Therefore, the user can recognize that the opened page is the page 105 by simply visually checking the positions of the check boxes 411, 420 and 435.

Further, the characters “Page 105” that indicate the content of the paper medium information are written in the character description portion 50. Therefore, the user can more reliably recognize the paper medium information “Page 105” of the paper medium 701 by checking both the positions of the character boxes 411, 420 and 435 and the characters “Page 105” in the character description portion 50.

When the user turns on the power source of the reading device 2, the main processing is performed. In the main processing, it is determined whether the paper medium information has been ascertained (S11). For example, if the user performs, on the input portion 22, an operation to notify that the paper medium information has been input, it is determined that the paper medium information has been ascertained (yes at S11). When the paper medium information has not been ascertained (no at S11), it is determined whether specification of a position (coordinates) on the placement portion 24 by the electronic pen 3 has been detected by the coordinate detection portion 25 (S 12). When the specification by the electronic pen 3 has not been detected (no at S12), the processing returns to S11. When the specification by the electronic pen 3 has been detected (yes at S12), the associated information data table 95 is referred to, and it is determined whether the detected position (coordinates) is the mark corresponding position (S13). When the position at which the specification by the electronic pen 3 has been detected is not the mark corresponding position (no at S13), the processing returns to S11. When the position at which the specification by the electronic pen 3 has been detected is the mark corresponding position (yes at S 13), the paper medium information associated with the mark corresponding position is identified in the associated information data table 95 (S14). Next, the paper medium information identified at S14 is stored in the RAM 203 (S15). Next, the processing returns to S11.

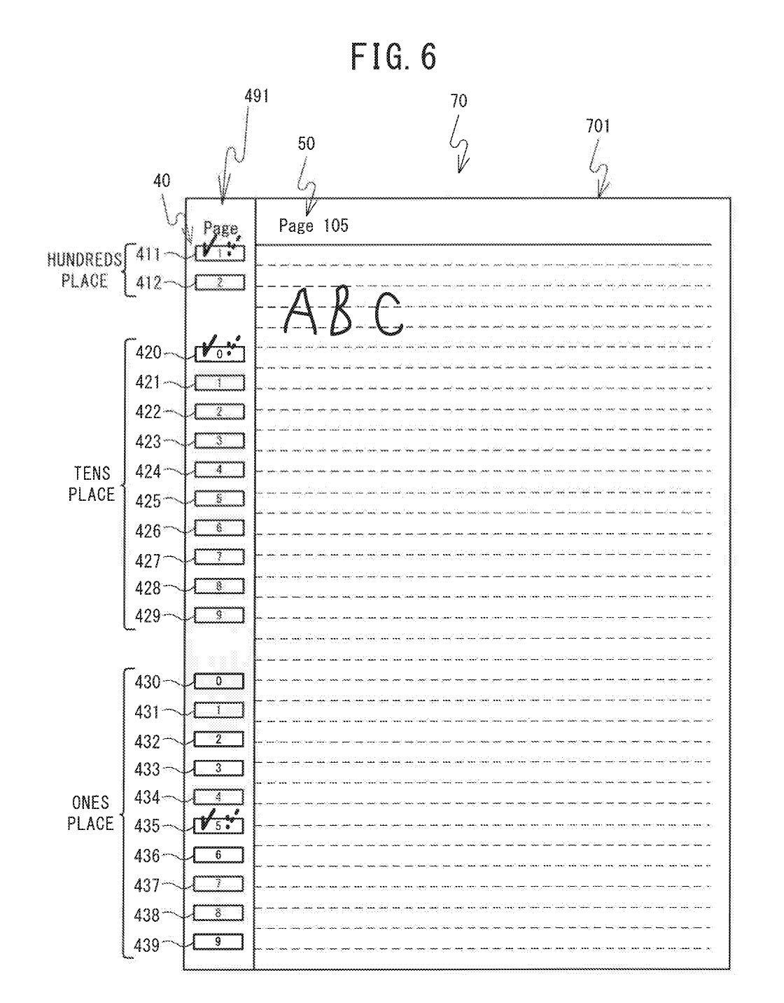

Specifically, the user enters check marks (solid check marks shown in FIG. 6) in the check boxes 411, 420 and 435 using the electronic pen 3 in a state in which the paper medium 701 of the page number “Page 105” is opened. When the user enters the check mark in the check box 411, the specification of the position (coordinates) on the placement portion 24 by the electronic pen 3 is detected by the coordinate detection portion 25 (yes at S12). The position of the check box 411 corresponds to the coordinates (X1, Y1) on the placement portion 24 (refer to FIG. 4). The coordinates (X1, Y1) are the mark corresponding position (refer to FIG. 4). Therefore, it is determined that the detected position (X1, Y1) is the mark corresponding position (yes at S13), and the paper medium information “hundreds place “1”” that is associated with the mark corresponding position (X1, Y1) in the associated information data table 95 is identified (S14). Next, the identified paper medium information “hundreds place “1”” is stored in the RAM 23 (S15).

Similarly to the above case, when the check marks are entered in the check boxes 420 and 435, the respective pieces of paper medium information “tens place “0”” and “ones place “5”” that are associated with the mark corresponding positions (X1, Y3) and (X1, Y18) that correspond to the check boxes 420 and 435 are identified (S14) and stored (S15). By performing the above-described processing, the paper medium information “Page 105” is stored in the RAM 23. Note that, in FIG. 6, illustrations of the reading device 2, the placement portion 24, the coordinate detection portion 25 and the like are omitted, and only the paper medium 70 is shown.

When the paper medium information is ascertained (yes at S11), it is determined whether the paper medium 70 is a paper medium whose written content has been stored in the past (S16). The above determination is made based on whether the coordinate data table 96 (refer to FIG. 8, to be described later) corresponding to the paper medium information identified at S14 and stored at S15 is stored in the coordinate storage area 2041. Note that the coordinate data table 96 is stored in the coordinate storage area 2041 at S21, which will be described later.

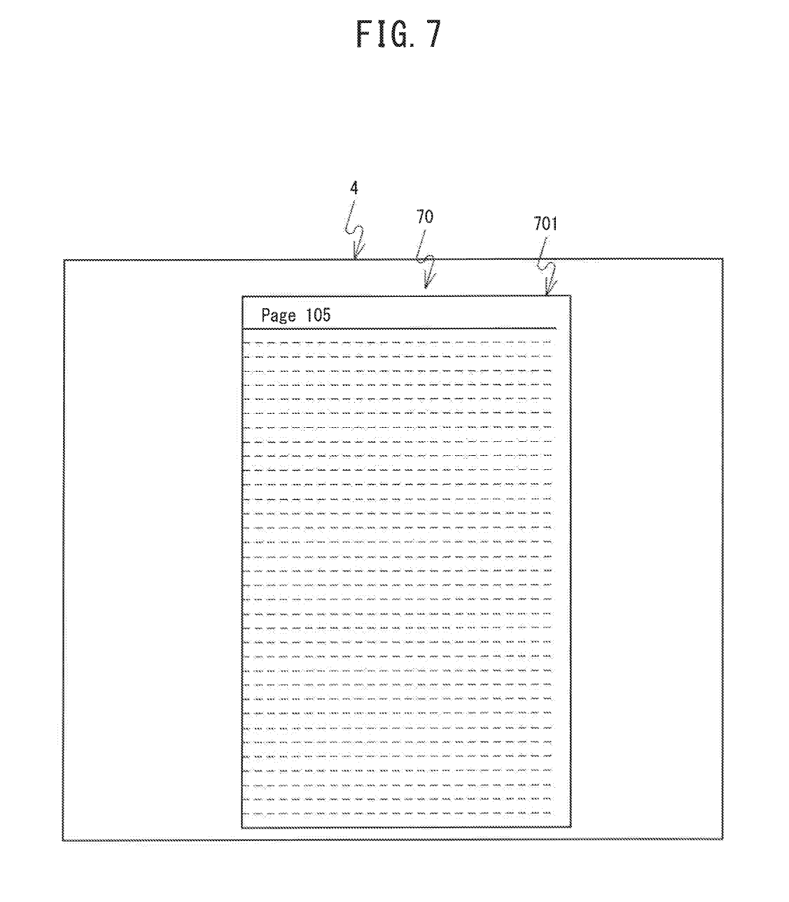

When the paper medium 70 is not the paper medium whose written content has been stored in the past (no at S16), a new image is read out from the image data storage area 2023 as an image corresponding to the paper medium information stored at S15, and is displayed on the display 4 (S17). For example, when the paper medium information “Page 105” is not the paper medium 70 whose written content has been stored in the past, a new image is displayed on the display 4 as an image corresponding to the paper medium information “Page 105” (refer to FIG. 7). Next, similarly to S12, it is determined whether specification of a position (coordinates) on the placement portion 24 by the electronic pen 3 has been detected by the coordinate detection portion 25 (S19). When the specification by the electronic pen 3 has not been detected (no at S19), it is determined whether the paper medium 701 is to be changed to another paper medium 70 (S20). At S20, when, for example, a command to change the paper medium 70 is input by an operation performed by the user on the input portion 22, it is determined that the paper medium 70 is to be changed. When the paper medium 70 is not to be changed (no at S20), the processing returns to S19.

When the specification of the position (coordinates) on the placement portion 24 by the electronic pen 3 is detected by the coordinate detection portion 25 (yes at S19), the detected position (coordinates) is stored in association with the paper medium information (S21). That is, the written content is stored. Next, the image displayed on the display 4 is updated based on the position (coordinates) and the paper medium information stored at S21 (S22). That is, the written content is displayed. Next, the processing returns to S19.

For example, as shown in FIG. 6, when the user writes the characters “ABC” on the paper medium 701 using the electric pen 3, the CPU 201 repeats S19, S21 and S22 during a period in which the characters “ABC” are written. It is assumed that, when the characters “ABC” are written in the position shown in FIG. 6, the coordinates on the placement portion 24 corresponding to the characters “ABC” are (X50, Y50)˜(X51, Y51)˜(X52, Y52). At this time, at S21, the coordinate data table 96 shown in FIG. 8 is created and stored.

The paper medium information and the coordinates detected at S19 are associated with each other and stored in the coordinate data table 96. More specifically, the paper medium information “Page 105” and the coordinates (X50, Y50)˜(X51, Y51)˜(X52, Y52) are stored in the coordinate data table 96. These coordinates are the coordinates specified by the electronic pen 3 and detected by the coordinate detection portion 25.

Further, based on the coordinate data table 96 shown in FIG. 8, the characters “ABC” written by the user are added to the image displayed on the display 4 and are displayed as shown in FIG. 9 (S22).

When the command to change the paper medium 70 is input by an operation performed by the user on the input portion 22, it is determined that the paper medium 70 is to be changed (yes at S20). For example, the user opens, on the placement portion 24, the page 106 that is different from the paper medium 701 of the page 105. Although not shown in the drawings, on the paper medium of the page 106, the check boxes 411, 420 and 436 corresponding to the page 106 are white on the colored background. In a similar manner to the case of the paper medium 701 of the page 105, the user enters check marks in the white check boxes 411, 420 and 436 of the page 106. In this case, information indicating that the paper medium information is “Page 106” is stored in the RAM 203 by the processing at S12 to S15, and an image of the page 106 is displayed on the display 4 (S17). When the user performs writing on the page 106 using the electronic pen 3, coordinates corresponding to the writing are stored in association with the paper medium information “Page 106” (S21), and are displayed (S22).

It is assumed that the user inputs the command to change the paper medium 70 (yes at S20) and once again opens the paper medium 701 of the page 105 on the placement portion 24. Then, the user once again enters check marks (dotted check marks shown in FIG. 6) in the check boxes 411, 420 and 435 of the paper medium 701. The paper medium information “Page 105” is identified by the above-described processing (S14) and is stored in the RAM 203 (S15). Thus, the paper medium information “Page 105” is ascertained (yes at S11). The paper medium information “Page 105” has already been stored in the coordinate data table 96 in association with the coordinates detected at S19 in the previous cycle (refer to FIG. 8). Therefore, it is determined that the content of the past writing has been stored (yes at S16). Then, based on the coordinate data table 96 stored in the coordinate storage area 2041, the content of the previous writing is once again displayed on the display 4 as shown in FIG. 9 (S18). Therefore, the user can newly perform writing following the previously written characters “ABC”. Next, S19 is performed. When the user newly performs writing (yes at S19), coordinates are added to the coordinate data table 96 (refer to FIG. 8) (S21) and are displayed on the display 4 (S22). As described above, the reading device 2 can store the new written content (coordinates) by adding it to the written content (coordinates) associated with the paper medium information stored in the coordinate storage area 2041.

The main processing is performed as described above. Note that, when the power source of the reading device 2 is turned off, the main processing is terminated. In the present embodiment, since the user specifies (enters check marks in) the check boxes 40 on the paper medium 701 using the electronic pen 3, the reading device 2 can identify the paper medium information (S 14). Thus, the reading device 2 can associate the identified paper medium information with the data (coordinates) corresponding to the written content written on the paper medium by the user, and can store the associated information (S21). Further, the reading device 2 can display, on the display 4, the image on the paper medium corresponding to the identified paper medium information (S17 and S18). Further, the reading device 2 can store the content that has been newly written such that the newly written content is added to the content written in the past by the user (S21), and can display it (S22). As described above, since the check marks are entered in the check boxes 40, the reading device 2 can read the paper medium information and can store and manage coordinates (written content) for each piece of the paper medium information. Thus, user friendliness is improved.

Further, since the user enters the check marks in the check boxes 40 using the electronic pen 3, the reading device 2 can identify the paper medium information. Therefore, there is no need to provide a member, such as a known code reader. It is thus possible to reduce the cost of the reading device 2. In addition, the space for providing the code reader can be omitted, and it is thus possible to reduce the size and thickness of the reading device 2.

Further, in the present embodiment, the check boxes 40 are provided in predetermined positions that correspond to the paper medium information. The check boxes 40 are normally used to prompt the user to enter check marks. Therefore, for example, in comparison with a case in which, instead of the check boxes 40, dots () or the like are provided in predetermined positions corresponding to the paper medium information, the check boxes 40 are more likely to attract the attention of the user. Therefore, the user can quickly confirm the positions of the check boxes 40. Thus, the user can effectively recognize the paper medium information based on the positions of the check boxes 40.

Further, since the check boxes are used to enter check marks, the user can easily cause the reading device 2 to recognize the paper medium information by entering check marks in the check boxes 40. It is thus possible to prevent the reading device 2 from failing to recognize the paper medium information due to the user forgetting to enter the check marks.

Further, the mark arrangement section 491 is colored in gray. Therefore, the mark arrangement section 491 visually stands out more in comparison with a case in which the mark arrangement section 491 is not colored and is a white color in the same manner as the other sections. Accordingly, the user can easily notice the existence of the check boxes 40. In other words, the gray colored mark arrangement section 491 can notify the user of the existence of check boxes 40. Thus, in comparison with a case in which the mark arrangement section 491 is not processed differently from the other sections, namely, a case in which the mark arrangement section 491 is not colored and is a white color in the same manner as the other sections, the user can more reliably confirm the paper medium information by visually checking the check boxes 40. Further, it is possible to prevent the user from forgetting to enter the check marks in the check boxes 40.

Note that the present disclosure is not limited to the above-described embodiment and various modifications are possible. For example, in addition to the white check boxes 411, 420 and 435, the check boxes 412, 421 to 434 and 436 to 439 (the gray colored check boxes 40) that are not white are listed on the paper medium 701. However, the check boxes 412, 421 to 434 and 436 to 439 that are not white need not necessarily be listed. Further, although the characters indicating the content of the paper medium information are written in the character description portion 50, the characters need not necessarily be written.

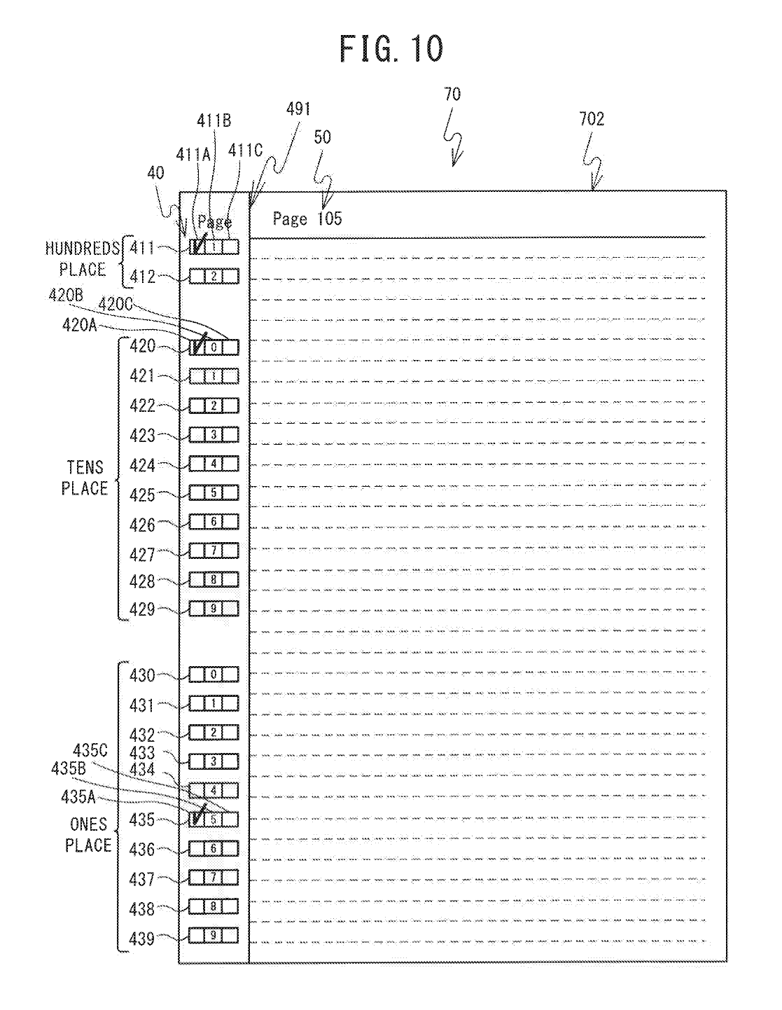

Further, the single check box 40 is provided in each of the predetermined positions that correspond to the paper medium information. For example, the single check box 411 corresponds to the hundreds place “1”. However, for example, a plurality of the check boxes 40 may be provided in each of the predetermined positions that correspond to the paper medium information. For example, on a paper medium 702 shown in FIG. 10, each of the check boxes 411, 412, 420 to 439 is formed by the three check boxes 40. For example, the check box 411 is formed by three check boxes 411A, 411B and 411C that are arranged side by side in the left-right direction. In a similar manner, the check box 420 is formed by check boxes 420A, 420B and 420C, and the check box 435 is formed by check boxes 435A, 435B and 435C.

In the example shown in FIG. 10, after the user places the paper medium 702 on the placement portion 24, the user enters a check mark in each of the leftmost check boxes 411A, 420A and 435A of the check boxes 411, 420 and 435. The paper medium information “Page 105” is identified by this processing (S14). Then, when the user writes given characters on the paper medium 702 using the electronic pen 3, the written content is stored (S21) and displayed on the display 4 (S22).

Next, it is assumed that the user opens the page 105 once again after the user has opened another page and performed writing (yes at S20). At this time, as shown in FIG. 10, the check marks have already been entered in the leftmost check boxes 411A, 420A and 435A of the check boxes 411, 420 and 435 on the paper medium 702. The other check boxes 411B, 411C, 420B, 420C, 435B and 435C are blank and the check marks have not been entered therein. In other words, there are the remaining check boxes 411B, 411C, 420B, 420C, 435B and 435C in which the check marks have not been entered. On the paper medium 701 shown in FIG. 6, only one check box is provided for each of the check boxes 411, 420 and 435. Therefore, if the paper medium 701 on which the check marks have already been entered in the check boxes 411, 420 and 435 is once again placed on the placement portion 24, there are no remaining check boxes 411, 420 and 435 in which the check marks have not been entered. As a result, in comparison with a case in which only one check box is provided for each of the check boxes 411, 420 and 435, the check marks stand out more on the paper medium 702 having the blank check boxes 411B, 411C, 420B, 420C, 435B and 435C. Thus, when the user recognizes the paper medium information based on the positions of the check marks, it is possible to more reliably confirm the positions of the check marks, and the user is unlikely to forget to enter the check marks in the check boxes 40. When the user enters the check marks in the center check boxes 411B, 420B and 435B that are blank, the paper medium information “Page 105” is identified (S14).

Further, since the plurality of check boxes 40 are provided in each of the predetermined positions that correspond to the paper medium information, the check boxes 40 stand out more in comparison with a case in which the single check box 40 is provided in each of the predetermined positions. Therefore, when the user recognizes the paper medium information based on the positions of the check boxes 40, the user can confirm the positions of the check boxes 40 more reliably. Thus, the user can effectively recognize the paper medium information.

Further, although the check boxes 40 are provided corresponding to the paper medium information, another mark, such as “dot ()” or “circle (◯)”, for example, may be used. Also in this case, the user can recognize the paper medium information simply by visually checking positions of dots or circles. Further, if the user places a check mark above a corresponding dot or circle using the electronic pen 3, the reading device 2 can identify the paper medium information (S14) and store the identified paper medium information (S15).

Further, the mark arrangement section 491 is colored in gray so that it is distinguished from the other sections. However, the mark arrangement section 491 is not limited to this example. For example, an adhesive may be applied to the mark arrangement section 491. In this case, every time a page of the paper medium 70 is opened, resistance of the adhesive is transmitted to a finger of the user. Therefore, due to the resistance, the user can easily become aware of the existence of the check boxes 40. Further, the mark arrangement section 491 may be formed of a material (for example, a rough textured material) that is different from that of the other sections. In this case, due to the difference in the material, the user can easily become aware of the existence of the check boxes 40. In this manner, if the mark arrangement section 491 is processed differently from the other sections, the user can easily become aware of the existence of the check boxes 40. It is thus possible to effectively perform confirmation of the paper medium information by visually checking the check boxes 40. Further, it is possible to prevent the user from forgetting to enter the check marks in the check boxes 40 using the electronic pen 3. Note that the mark arrangement section 491 need not necessarily be processed differently from the other sections.

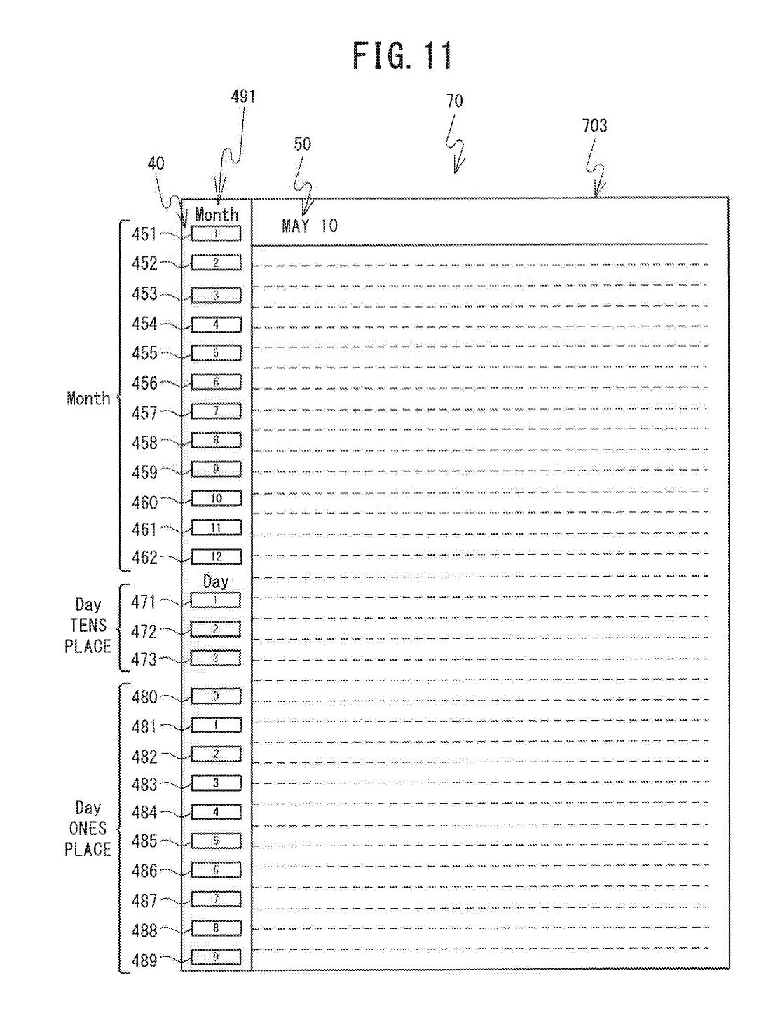

Further, in the above explanation, the paper medium information is a page number. However, instead of the page number, the paper medium information may be a date, a format or the like. For example, on a paper medium 703 shown in FIG. 11, the paper medium information is a date. Check boxes 451 to 462, 471 to 473 and 480 to 489 of the paper medium 703 correspond to the date. In more detail, the check boxes 451 to 462 correspond to “1” to “12” of “Month”. The check boxes 471 to 473 correspond to “1” to “3” in the tens place of “Day”. The check boxes 480 to 489 correspond to “0” to “9” in the ones place of “Day”.

In the example shown in FIG. 11, the check boxes 455, 471 and 480 are white on the colored background. The white check boxes 455, 471 and 480 indicate that the paper medium information of the paper medium 703 is “May 10”. The user memorizes in advance a corresponding relationship between a date (paper medium information) and positions of the check boxes 451 to 462, 471 to 473 and 480 to 489. The user can recognize that the paper medium information of the paper medium 703 is the date “May 10”, by confirming the positions of the white check boxes 455, 471 and 480. Further, similarly to the above-described case in which the paper medium information is the page number, the reading device 2 stores coordinates (mark corresponding positions) of the check boxes 451 to 462, 471 to 473 and 480 to 489 in the data table storage area 2022 such that the coordinates are associated with the date. In this case, when the user enters check marks in the check boxes 455, 471 and 480 using the electronic pen 3 in a state in which the paper medium 703 is placed on the placement portion 24 of the reading device 2, the reading device 2 identifies that the date of the placed paper medium 703 is “May 10” (S14). Note that, since the paper medium information of the paper medium 703 is “May 10”, the date “May 10” is written in the character description portion 50.

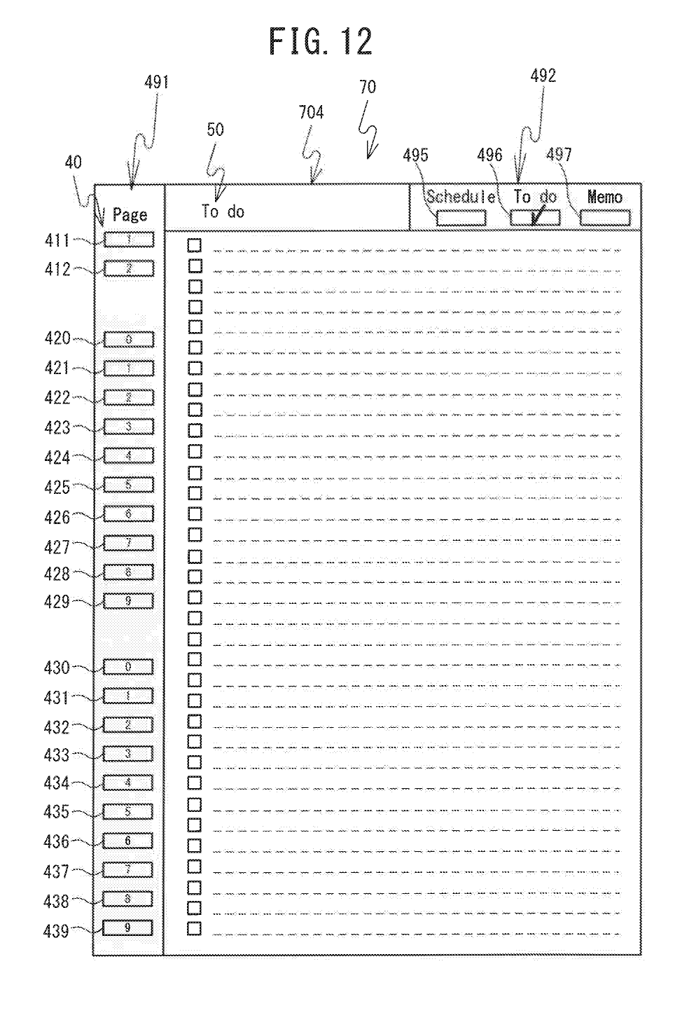

The paper medium information relating to a paper medium 704 shown in FIG. 12 is a format. A mark arrangement section 492 is provided in a rear right portion of the paper medium 704. The mark arrangement section 492 is colored in gray. The mark arrangement section 492 exhibits the same effect as that of the mark arrangement section 491. Check boxes 495, 496 and 497 are provided in the mark arrangement section 492. Each of the check boxes 495, 496 and 497 corresponds to a format. In more detail, the check box 495 corresponds to a “Schedule format”. The check box 496 corresponds to a “To do format”. The check box 497 corresponds to a “Memo format”.

In the example shown in FIG. 12, the check box 496 is white on the colored background. The position of the white check box 496 indicates that the paper medium information of the paper medium 704 is the “To do format”. The user memorizes in advance corresponding relationships between the formats and the positions of the check boxes 495, 496 and 497. By confirming the position of the white check box 496, the user can recognize that the paper medium information of the paper medium 704 is the “To do format”. Further, the reading device 2 associates coordinates (mark corresponding positions) of the check boxes 495, 496 and 497 with the formats, and stores the associated coordinates and formats in the data table storage area 2022. In this case, when the user enters a check mark in the check box 496 using the electronic pen 3 in a state in which the paper medium 704 is placed on the placement portion 24 of the reading device 2, the reading device 2 identifies that the placed paper medium 704 is the “To do format”. Then, an image of the “To do format” is displayed on the display 4 (S17 and S18). Note that the image of each format is read out from the image data storage area 2023, for example.

Note that a plurality of pieces of paper medium information may be combined. For example, the check boxes 40 for the date, the format and the page number may be provided on the single paper medium 70. Then, at S21, the coordinates may be stored in association with the combination of the plurality of pieces of paper medium information.

What is claimed is:

1. A paper medium comprising:
a mark that is provided at each of predetermined positions corresponding to paper medium information that is predetermined information relating to the paper medium.

2. The paper medium according to claim 1, wherein
the mark is a check box.

3. The paper medium according to claim 1, wherein
a plurality of the marks are provided in each of the predetermined positions.

4. The paper medium according to claim 1, further comprising:
characters indicating content of the paper medium information.

5. The paper medium according to claim 1, further comprising:
a mark arrangement section that is a section in which the mark is arranged, the mark arrangement section being processed differently from other sections.

6. The paper medium according to claim 5, wherein
the mark arrangement section is colored differently from the other sections.

7. The paper medium according to claim 6, wherein
the mark has a color different from that of the mark arrangement section.

8. The paper medium according to claim 5, wherein
an adhesive is applied to the mark arrangement section.

9. The paper medium according to claim 5, wherein
the mark arrangement section is formed of a material different from that of the other sections.

10. The paper medium according to claim 1, wherein
the paper medium information is a page number of the paper medium.

11. The paper medium according to claim 1, wherein
the paper medium information is a date.

12. The paper medium according to claim 1, wherein
the paper medium information is a format of the paper medium.

13. A reading device comprising:
a processor; and
a memory configured to store associated information that is information in which a mark corresponding position is associated with paper medium information on a placement device that is configured to which the paper medium according to claim 1 is placed on, the mark corresponding position being a position corresponding to a predetermined position in which a mark is arranged, and to store computer-readable instructions therein,
wherein the computer-readable instructions instruct the processor to perform processes comprising:
detecting a position specified on the placement device;
determining whether the position detected on the placement device is the mark corresponding position;
referring to the associated information; and
identifying the paper medium information associated with the mark corresponding position when the detected position is the mark corresponding position.

14. A reading device comprising:
a placement device that is configured to which the paper medium according to claim 1 is placed on;
a specification device that specifies a position on the paper medium placed on the placement device;
a detection device that is provided on the placement device and that detects the position specified on the placement device by the specification device;
a storage device that stores associated information that is information in which a mark corresponding position is associated with paper medium information, the mark corresponding position being a position on the placement device that corresponds to a predetermined position in which a mark is arranged; and
an identification device that refers to the associated information stored in the storage device, and identifies the paper medium information associated with the mark corresponding position when the position on the placement device detected by the detection device is the mark corresponding position.
